(19) United States
(12) Patent Application Publication
(10) Pub. No.: US 2012/0108410 A1
(43) Pub. Date: May 3, 2012

(54) DEVICE AND A METHOD FOR APPLYING LATERAL TABS IN THE MANUFACTURE OF PANT TYPE NAPPIES OR DIAPERS

(75) Inventors: Alberto Perego, Milano (IT); Matteo Piantoni, Albino (Bergamo) (IT)

(73) Assignee: GDM S.P.A., Bologna (IT)

(21) Appl. No.: 13/381,584

(22) PCT Filed: Jul. 26, 2010
(86) PCT No.: PCT/IB10/53380

§ 371 Date: Dec. 29, 2011

(30) Foreign Application Priority Data
Aug. 5, 2009 (IT) BO2009A000525

(51) Int. Cl. B32B 37/12; B31D 1/00; B32B 38/18

(52) U.S. Cl. 493/334; 493/379; 493/380; 493/345

(57) ABSTRACT

Pant type nappies, or diapers, are provided with lateral tabs applied by a device comprising a conveyor (10) on which absorbent central bodies (3), one per nappy (2), are caused to advance in succession along a given feed direction (D), also a feed device (12) facing the conveyor (10) and supplying a succession of prefolded lateral tabs (4), ordered in pairs. A pair of tabs (4) is placed on each absorbent central body (3) in turn, and at least a first end (4a) of each tab (4) fixed to one corresponding edge of the body. The device further comprises a folding mechanism operating along the conveyor (10), downstream of the feed device (12), by which the successive absorbent central bodies (3) are bent double, and respective second ends (4b) of the two lateral tabs (4) fastened to the edges of the body (3).

### TECHNICAL FIELD

The present invention relates to a device and a method for the application of lateral tabs in the manufacture of pant type nappies or diapers.

### BACKGROUND ART

In particular, pant type nappies comprise an absorbent central section, or body, of substantially rectangular outline.

The central body comprises an absorbent pad sandwiched between a backsheet of impermeable material—such as polyethylene—constituting the outer layer of the nappy, and a topsheet of permeable material—such as non-woven fabric—constituting the inner layer of the nappy.

Pant type nappies also comprise a pair of lateral tabs, attached by their opposite ends to the lateral edges of the absorbent central body, which is folded double. In practice, the effect of folding the absorbent central body double is to create a front portion and a rear portion of the nappy. Accordingly, the tabs serve to interconnect the front portion and the rear portion of the nappy.

In use, more exactly, the lateral tabs hug the hips of a wearer and serve, in combination with the lateral edges of the folded absorbent central portion, to create respective leg holes contoured anatomically to the wearer's limbs.

The lateral tabs are fashioned, by way of example, from a material such as non-woven fabric, and preferably a stretch fabric, making the nappy easy to wear and readily adaptable to the body of the wearer.

When manufacturing pant type nappies or diapers, accordingly, the process includes a specific step in which the lateral tabs are applied to the absorbent central body of the nappy.

The step in question involves attaching first ends of the tabs to each outer edge of the absorbent central body. The tabs are attached, by way of example, using an adhesive.

Thereafter, the absorbent central body is bent double in such a way as to fold the front portion and the rear portion of the selfsame central body into contact one with another.

Once the fold has been made, second ends of the tabs are attached to the absorbent central body so as to complete the nappy. These second ends can also be attached with adhesive, by way of example. Alternatively, the second ends can be attached utilizing detachable fastening means such as strips of Velcro®, for example.

Finally, portions of the tabs projecting beyond the lateral outline of the absorbent pad are inserted between the front and rear portions. This is accomplished by easing the front portion away from the rear portion and tucking the tabs between the two portions.

Conventionally, a device capable of performing this sequence of steps will comprise means by which to convey a succession of absorbent central bodies along a predetermined feed direction. By way of example, such means might comprise a conveyor belt on which the absorbent central bodies are placed, having been assembled previously at respective processing stations of a nappy manufacturing system.

The conveying means carry the succession of absorbent central bodies toward a first application component by which first ends of the aforementioned lateral tabs are attached to the outer edges of each absorbent central body.

Downstream of the first component, the central body is bent double by a folding device to establish the front portion and the rear portion.

Second ends of the lateral tabs are then attached to the central body—detachably or otherwise—by a second application component. Viewed in plan, the assembled nappy appears at this point with lateral tabs projecting from the outline of the padded section, and is carried by the conveying means toward a positioning component of which the function is to tuck the lateral tabs between the front portion and the rear portion.

The positioning component comprises first means, for example suction means, serving to retain one portion (front or rear) of each absorbent central body on the conveying means, and second means, likewise using suction for example, to lift the other portion (rear or front).

Finally, the projecting parts of the lateral tabs are directed by rotary diverter elements between the front portion and the rear portion, hence brought within the outline of the folded nappy.

Disadvantageously, both the device and the method of application described above are notably complex.

In the case of the device, it will be appreciated that when the absorbent central body is bent double, the lateral tabs must be held stably in the open position, spread apart; thereafter, when the pant is fully assembled and the tabs must be tucked between the folded portions of the pad, first and second means are required for the purpose of easing the front and rear portions apart, in addition to the diverter means aforementioned, and the operation and movements of all these components must be properly coordinated.

Accordingly, when considering both the device and the method, it is due precisely to the complex nature of these operations that the speed with which the lateral tabs are applied to the absorbent central bodies tends to be decidedly limited.

### DISCLOSURE OF THE INVENTION

Accordingly, the object of the present invention is to provide a device and a method for applying lateral tabs in the manufacture of pant type nappies, or diapers, in which the above noted drawbacks associated with the prior art are overcome.

One object of the present invention, in particular, is to provide a device and a method for applying lateral tabs in the manufacture of pant type nappies, such as will be instrumental in simplifying the process by which the product is manufactured.

The stated objects are realized in a device for applying lateral tabs in the manufacture of pant type nappies, of which the features are recited in one or more of claims 1 to 10 appended, and in a method of applying lateral tabs in the manufacture of pant type nappies, of which the features are recited in one or more of claims 11 to 17 appended.

### BRIEF DESCRIPTION OF THE DRAWINGS

The invention will now be described in detail, by way of example, with the aid of the accompanying drawings, in which:

FIG. 1 shows a device according to the present invention for applying lateral tabs in the manufacture of pant type nappies, illustrated schematically and in perspective;

FIG. 2 is a schematic side elevation view of the device shown in FIG. 1;

FIGS. 3, 4 and 5 are cross sectional side views illustrating respective steps in the manufacture of a pant type nappy;

FIGS. 6 and 7 are perspective views of the pant type nappy, shown in respective open configurations, when not in use.

### DETAILED DESCRIPTION OF THE PREFERRED EMBODIMENTS

With reference to the accompanying drawings, numeral 1 denotes a device according to the present invention, in its entirety, for applying lateral tabs in the manufacture of pant type nappies.

The device 1 in question is designed to implement a method of applying lateral tabs in the manufacture of pant type nappies, according to the present invention.

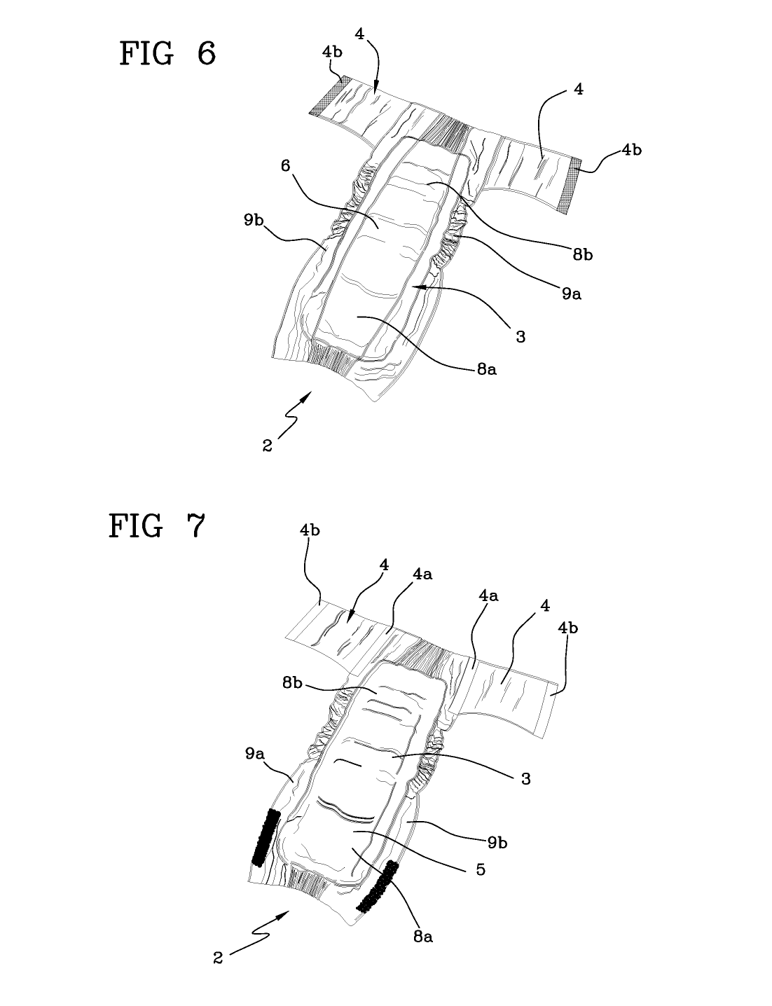

With reference in particular to FIGS. 6 and 7, a nappy or diaper of pant type, denoted 2, comprises an absorbent central body 3 and a pair of lateral tabs 4 attached to the central body 3.

The lateral tabs are fashioned, by way of example, from a material of non-woven fabric type, preferably stretch fabric.

The absorbent central body 3 of a pant type nappy presents a substantially rectangular outline and comprises an outer layer 5 of impermeable material, also an inner layer 6 of permeable material.

The outer layer 5 is made of plastic material, for example, preferably polyethylene, and referred to generally as the backsheet.

The inner layer 6 is made of non-woven fabric, for example, and referred to generally as the topsheet.

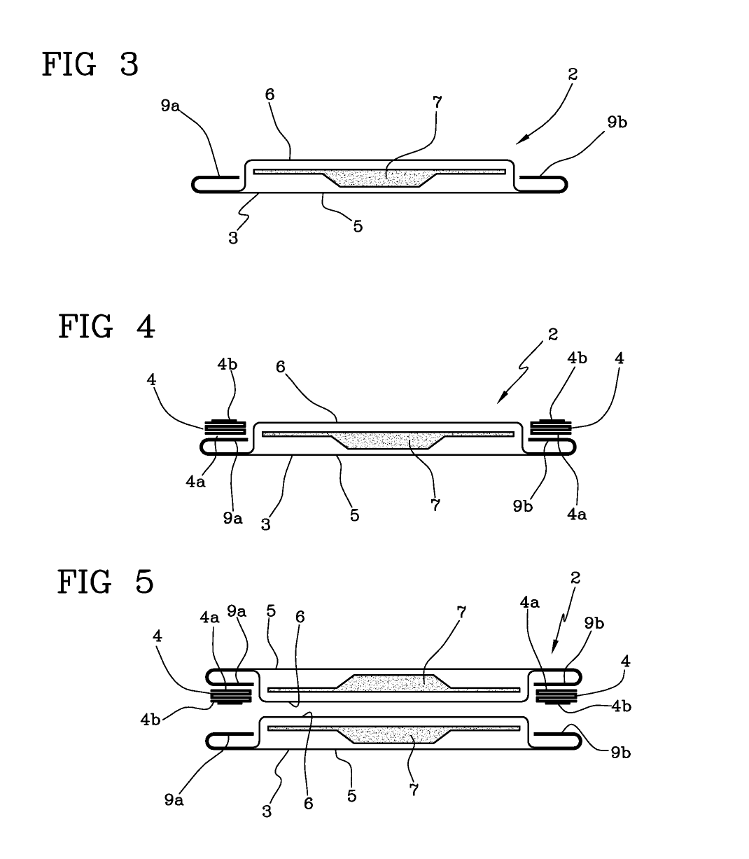

The absorbent central body 3 further comprises an absorbent pad 7 sandwiched between the outer layer 5 and the inner layer 6 (FIG. 3). The absorbent pad 7 can consist, for example, in a mass of cohesionless fibres, or fluff.

The absorbent central body 3 is bent double at least in part, in such a way as to create two portions folded one against the other. As a result of this step, in particular, the nappy is divided into a front portion 8a and a rear portion 8b, referred to the position of the pant on the body of the wearer.

The two lateral tabs 4 are thus positioned to join the front portion 8a of the absorbent central body 3 to the rear portion 8b at points coinciding with the opposite ends of the selfsame central body 3.

More exactly, the lateral tabs 4 are positioned at each end of the absorbent central body 3 and attached to respective lateral edges 9a and 9b presented by the central body 3.

Packaged and ready for use, pant type nappies 2 appear folded double, with the lateral tabs 4 tucked in between the breasted surfaces of the front portion 8a and the rear portion 8b.

The method according to the present invention for applying tabs 4 in the manufacture of pant type nappies 2 includes the step of feeding a succession of central bodies 3 prepared and assembled in familiar manner (FIG. 3). In particular, the absorbent central bodies 3 are conveyed along a predetermined feed direction D.

The method disclosed also includes the step of feeding a succession of pairs of prefolded lateral tabs 4, each folded double at least once (FIG. 4). In particular, the prefolded tabs 4 are fed toward each absorbent central body 3 and attached thereto.

In greater detail, the prefolded tabs 4 of each successive pair are fixed, each by a respective first end 4a, to the lateral edges 9a and 9b of one central body 3.

The aforementioned first ends 4a of the prefolded tabs 4 are fixed with adhesive. To this end, the method includes a specific gluing step performed on the first ends 4a of each pair of lateral tabs 4 prior to the application step. In the course of the gluing step, accordingly, each of the first ends 4a is coated with a layer of adhesive.

The lateral tabs 4, to reiterate, are already folded at the moment of being attached to the absorbent central body 3. In effect, the lateral tabs 4 undergo a folding step performed, to advantage, at least before the application step.

In practice, the lateral tabs 4 are folded double more than once, in such a way that each individual tab presents a concertina folded configuration (FIGS. 4 and 5).

To advantage, the lateral tabs 4 are prepared by cutting from a continuous strip 14 of tab material.

In other words, the aforementioned step of feeding the succession of pairs of lateral tabs 4 comprises a step of deploying the strip 14 and cutting it into discrete pieces, each providing one lateral tab 4.

Advantageously, the continuous strip 14 will be concertina folded lengthwise, in such a way that successive cuts have the effect of producing concertina-folded lateral tabs 4 instantaneously.

According to the method disclosed, in particular, two strips 14 will be deployed in such a way that each successive pair of lateral tabs 4 is produced by cutting respective pieces from the two strips.

Given that each previously concertina folded lateral tab 4 is offered to a respective lateral edge 9a and 9b of the absorbent central body 3, the two strips 14 follow feed paths aligned substantially on respective vertical planes occupied by the selfsame lateral edges 9a and 9b.

During the application of the lateral tabs 4, preferably, the absorbent central bodies 3 are conveyed one behind the next with the inner layer 6 lying above the outer layer 5. This is particularly advantageous in view of what follows, as will become clear.

The lateral tabs 4 are attached to the backsheet, in other words the outer face, of each absorbent central body 3.

Accordingly, the method disclosed includes a step in which the lateral edges 9a and 9b of each absorbent central body 3 are folded double, in such a way that the outer face will be directed upward.

Thus, the first ends 4a of the lateral tabs 4 are applied to the respective outer faces of the two lateral edges 9a and 9b.

Once the first ends 4a of the lateral tabs 4 have been secured, each central body 3 is cut and separated from the next, and thereupon bent double, in a manner familiar to a person skilled in the art. Preferably, the central bodies 3 are bent along a fold line extending substantially at right angles to the feed direction D.

In particular, the absorbent central bodies 3 are folded in such a way that the inner layer 6 is bent double and contained completely between the two folds of the outer layer 5 (FIG. 5).

The folding operation is advantageously simplified precisely by virtue of the fact, as mentioned previously, that the absorbent central bodies 3 are conveyed in succession with the inner layer 6 positioned above the outer layer 5.

The method includes a further step of connecting second ends 4b of the lateral tabs 4 to the respective absorbent central body 3. Preferably, this further step will be an automatic consequence of the folding step whereby the absorbent central body 3 is bent double.

To this end, it will be seen that when the absorbent central body 3 has been bent double, the backsheet faces of the lateral edges 9a and 9b are positioned facing one another, internally of the folded central body 3.

In other words, the second end 4b of each lateral tab 4 is offered directly to the folded outer face of the lateral edge 9a and 9b presented by the end of the absorbent central body 3 opposite to that associated with the first ends 4a of the tabs 4. By virtue of the folding operation, accordingly, the second ends 4b of the lateral tabs 4 are offered in contact and thus connectable to the lateral edges 9a and 9b.

To this end, the second ends 4b of the lateral tabs 4 can be attached by applying adhesive before the parts are positioned one relative to another. In this instance, the tabs will not subsequently be detachable from the edges.

Alternatively, the tabs can be connected detachably, utilizing at least one pair of fastenable elements such as Velcro® strips.

These same elements can be attached to the second ends 4b of the lateral tabs 4 or to the lateral edges 9a and 9b, either with adhesive or by welding mechanically.

Having been applied to the respective absorbent central body 3 to complete the assembly of the pant nappy 2, the lateral tabs 4 can be subjected advantageously to a pressing step such as will serve to improve the bond between the glued or welded components and compact the nappy further.

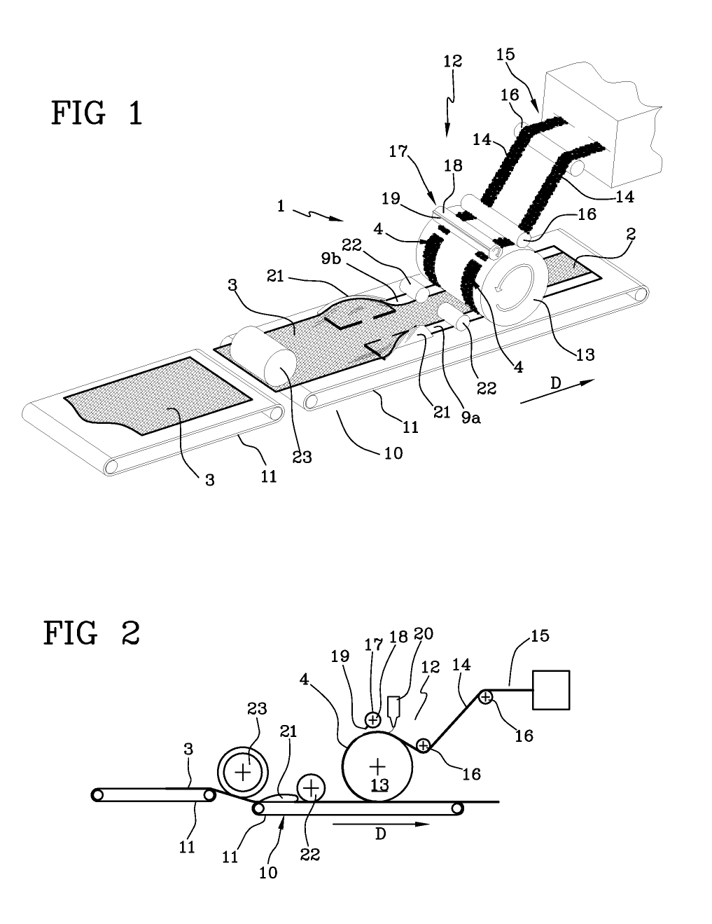

Referring to FIGS. 1 and 2, the application device 1 according to the invention comprises a conveyor component 10 by which the absorbent central bodies 3 are caused to advance in succession along the aforementioned feed direction D. By way of example, the conveyor component 10 comprises at least one conveyor belt 11 on which absorbent central bodies 3 emerging from a production unit (not illustrated) are placed and caused to advance in succession. In the example of FIGS. 1 and 2, the conveyor component 10 comprises two conveyor belts 11 operating in tandem along the feed direction D.

The application device 1 further comprises a feed device 12 supplying pairs of prefolded lateral tabs 4, by which the selfsame prefolded tabs 4 are associated with and applied to the absorbent central bodies 3 advancing in succession on the conveyor component 10.

To this end, the feed device 12 is located along the feed direction D, positioned facing and in close proximity to the conveyor component 10.

The feed device 12 comprises an application roller 13 on which the prefolded lateral tabs 4 are prepared and positioned in pairs, by steps shortly to be described. The lateral tabs 4 are first positioned by the application roller 13 in close proximity to the corresponding absorbent central body 3, then transferred to the selfsame body. Advantageously, the application roller 13 is an aspirating roller. More exactly, the application roller 13 presents a surface of revolution pierced with holes through which an aspirating flow of air can be generated by vacuum means (not illustrated), in such a way that the lateral tabs 4 will be retained on the roller 13 during the aforementioned positioning and transfer steps.

The application roller 13 is positioned along the path of the conveyor component 10. In particular, the application roller 13 revolves substantially tangential to one of the conveyor belts 11, and is disposed transversely to the feed direction D.

As regards the preparation of the prefolded lateral tabs 4, this is accomplished by folding at least two continuous strips 14 of the tab material longitudinally, preferably forming a concertina type fold.

The two strips 14, initially flat and decoiled from respective rolls (not illustrated), are concertina-folded by an upstream folding unit of familiar type (not illustrated), whereupon the prefolded strips 14 are taken up by suitable conveying means 15 and caused to advance parallel with one another toward the feed device 12.

As illustrated in FIGS. 1 and 2, the conveying means 15 further comprise one or more intermediate rollers 16 serving to keep the prefolded strips 14 suitably tensioned.

The feed device 12 further comprises a cutter component 17 serving to divide the pair of strips 14 into a succession of pairs of lateral tabs 4. More exactly, the cutter component 17 is associated with the application roller 13 and comprises a rotating cylinder 18 equipped with a blade 19 extending longitudinally along the selfsame cylinder.

The cylinder 18 rotates counter to the application roller 13 in such a way that the blade 19 will strike against the application roller 13 and separate a pair of lateral tabs 4 with each stroke.

The lateral tabs 4 are attached to the relative absorbent central bodies 3 preferably by gluing. Accordingly, and as illustrated in the preferred embodiment of FIG. 2, the application device 1 will comprise a gluing device 20 positioned to coincide with the feed device 12, by which the aforementioned first ends 4a of the lateral tabs 4 are coated with a layer of adhesive.

As discernible in FIG. 2, the gluing device 20 is positioned adjacent to the application roller 13. More precisely, the gluing device 20 is positioned upstream of the cutter component 17 in such a way as to apply the adhesive to the strips 14 before the lateral tabs 4 are cut. An alternative solution might be to position the gluing device 20 downstream of the cutter component 17, so as to apply the adhesive to the lateral tabs 4 when already cut.

To advantage, the application device 1 according to the present invention comprises a pair of diverter elements 21 positioned upstream of the feed device 12, by which the lateral edges 9a and 9b of the absorbent central bodies 3 are folded double as the selfsame bodies advance along the feed direction D. Thus, the backsheet faces of the lateral edges 9a and 9b are turned and directed toward the feed device 12.

The diverter elements 21 are preferably of helical geometry. In other words, each diverter element 21 consists in a respective foil of helical profile such as will force the lateral edge 9a and 9b to bend along the feed direction followed by the absorbent central bodies 3.

The device 1 further comprises a pair of flattening rollers 22 operating downstream of the diverter elements 21. The flattening rollers 22 are placed between the diverter elements 21 and the application roller 13, in such a way as to keep the lateral edges 9a and 9b pressed down and allow the application of the lateral tabs 4. To this end, the flattening rollers 22 are centred on an axis of rotation orthogonal to the feed direction D.

Thus, each flattening roller 22 and the relative diverter element 21 are aligned with a respective strip 14 along the feed direction D.

Also operating in a position near to the diverter elements 21 is a press roller 23 serving to prepare the absorbent central bodies 3 for the step of folding the lateral edges 9a and 9b. The press roller 23 is located upstream of the diverter elements 21 and positioned centrally between the two.

In accordance with the present invention, the application device 1 further comprises a folding component (not shown in the accompanying drawings) by which the absorbent central bodies 3 are bent double. The folding component will operate downstream of the feed device 12, along the conveyor component 10.

In addition to bending the absorbent central bodies 3 double, the folding component also serves to bring the second ends 4b presented by each pair of lateral tabs 4 into contact with the lateral edges 9a and 9b at the end of the body 3 opposite from that to which the first ends 4a are attached.

The second ends 4b of the tabs 4 are attached to the central body 3 by gluing. Accordingly, the application device 1 will also comprise a second gluing device (not illustrated) operating preferably upstream of the folding component and serving to coat the second ends 4b of the tabs 4 with a layer of adhesive.

Alternatively, in the event that the second ends 4b are to be fastened detachably, the application device 1 comprises a component (not shown) such as will apply strips of Velcro® type material to the lateral edges 9a and 9b of the absorbent central bodies 3, or to the second ends 4b of the lateral tabs 4.

The objects stated at the outset are achieved by the present invention.

In effect, by using concertina folded lateral tabs, prepared previously, it becomes possible to avoid the additional steps of repositioning the tabs within the outline of the nappy so as to minimize its dimensions.

In other words, with the lateral tabs attached to the absorbent central bodies, the dimensions of the assembled nappies, viewed in plan, will already be the most compact obtainable.

Consequently, there is no need either for further processing operations, or for specific components of the device to perform them.

Both the method and the device are therefore notably simplified, in comparison to the prior art.

Precisely by virtue of this simplification, moreover, the production tempo of the manufacturing system can be increased without any increased risk of errors and rejects.

1. A device for applying lateral tabs in the manufacture of pant type nappies, or diapers, comprising:
a conveyor component by which absorbent central bodies of nappies are caused to advance in succession along a feed direction;
a feed device positioned facing the conveyor component and supplying successive pairs of prefolded lateral tabs, such as will place the tabs and apply at least respective first ends of the selfsame prefolded lateral tabs to the absorbent central bodies;
a folder component, operating downstream of the feed device along the conveyor component, by which the absorbent central bodies are bent double, and by which respective second ends of the lateral tabs are connected to each absorbent central body.

2. A device as in claim 1, further comprising conveying means by which at least two continuous strips of lateral tabs are caused to advance paired and parallel one with another toward the feed device.

3. A device as in claim 2, wherein the feed device further comprises a cutter component by which each continuous strip is divided into a succession of discrete lateral tabs.

4. A device as in claim 1, wherein the feed device comprises an application roller operating along the conveyor component, by which the lateral tabs are positioned on each absorbent central body.

5. A device as in claim 4, wherein the application roller turns on an axis of rotation disposed transversely to the feed direction.

6. A device as in claim 1, further comprising at least one gluing device positioned and operating in close proximity to the feed device and serving to coat each of the lateral tabs with a respective layer of adhesive.

7. A device as in claim 1, further comprising a pair of preferably helical diverter elements positioned upstream of the feed device, relative to the feed direction, by which respective lateral edges of each absorbent central body are folded double along the selfsame feed direction.

8. A device as in claim 7, further comprising at least one pair of flattening rollers operating adjacent to and downstream of the helical diverter elements, relative to the feed direction.

9. A device as in claim 7, further comprising a press roller operating adjacent to and upstream of the helical diverter elements, relative to the feed direction.

10. A device as in claim 1, wherein each diverter element is positioned substantially in alignment with each continuous strip of lateral tabs along the feed direction.

11. A method of applying lateral tabs in the manufacture of pant type nappies, or diapers, including the steps of:
feeding successive previously assembled absorbent central bodies of nappies along a feed direction;
feeding successive pairs of lateral tabs, double-folded previously to at least two thicknesses;
fixing at least first ends of a pair of lateral tabs to the lateral edges of each absorbent central body;
folding the absorbent central body double;
connecting second ends of the lateral tabs to the absorbent central body.

12. A method as in claim 11, wherein the step of feeding the prefolded lateral tabs includes the step of folding the tabs before the first ends of the selfsame tabs are fixed to the absorbent central body.

13. A method as in claim 12, wherein the step of feeding the prefolded lateral tabs includes the steps of deploying at least one continuous strip of such tabs and cutting the selfsame strip into discrete lengths to obtain the single lateral tabs.

14. A method as in claim 11, wherein the prefolded lateral tabs are concertina-folded.

15. A method as in claim 11, including a further step in which lateral edges of each absorbent central body are folded double along the feed direction, whereupon the first ends of the prefolded lateral tabs are applied to the selfsame folded lateral edges.

16. A method as in claim 11, wherein the step of connecting the second ends of the lateral tabs is an automatic consequence of the step whereby the absorbent central body is bent double.

17. A method as in claim 11, further comprising the step of coating the lateral tabs with a layer of adhesive before fixing the first ends of the selfsame lateral tabs.
